(19) United States
(12) Patent Application Publication
(10) Pub. No.: US 2026/0329083 A1
(43) Pub. Date: Oct. 22, 2026

(54) LIGHT GUIDE PLATE AND AR DISPLAY DEVICE

(71) Applicant: Sharp Kabushiki Kaisha, Osaka (JP)

(72) Inventors: Takeshi OYAMA, Sakai City (JP); Ryosuke SAIGUSA, Sakai City (JP); Yuichi KAWAHIRA, Sakai City (JP); Shintaro YAMADA, Sakai City (JP); Kiyoshi MINOURA, Sakai City (JP); Akira SAKAI, Sakai City (JP)

(21) Appl. No.: 19/649,277

(22) Filed: Apr. 16, 2026

(30) Foreign Application Priority Data
Apr. 22, 2025 (JP) 2025-070540

(51) Int. Cl. G02B 27/01; G02B 6/34

(52) U.S. Cl. CPC G02B 27/0101; G02B 6/34

(57) ABSTRACT

Provided are a light guide plate and an AR display device that can be mass-produced and achieve a wide viewing angle. The light guide plate sequentially includes a first substrate, a photoalignment film, a polymerized liquid crystal layer containing a cured product of a polymerizable liquid crystal, an adhesive layer, and a second substrate having a different refractive index from the first substrate. The light guide plate further includes a diffractive element.

### CROSS-REFERENCE TO RELATED APPLICATIONS

The present application claims priority under 35 U.S.C. § 119 to Japanese Patent Application No. 2025-070540 filed on Apr. 22, 2025, the contents of which are incorporated herein by reference in their entirety.

### BACKGROUND

### Technical Field

The following disclosure relates to light guide plates and AR display devices.

### Description of Related Art

JP 2024-161574 A discloses a light guide plate for image display as a technique related to light guide plates. The light guide plate includes a first resin base, a first barrier layer, and a hologram layer. The first barrier layer is disposed on the surface of the hologram layer.

### SUMMARY

The present disclosure aims to provide a light guide plate and an AR display device that can be mass-produced and achieve a wide viewing angle.
(1) One embodiment of the present invention relates to a light guide plate sequentially including: a first substrate; a photoalignment film; a polymerized liquid crystal layer containing a cured product of a polymerizable liquid crystal; an adhesive layer; and a second substrate having a different refractive index from the first substrate, the light guide plate further including a diffractive element.
(2) In an embodiment of the present invention, the light guide plate includes the structure (1), and the second substrate and the adhesive layer each have a higher refractive index than the first substrate.
(3) In an embodiment of the present invention, the light guide plate includes the structure (1) or (2), and the second substrate and the adhesive layer each have a refractive index that is higher than the refractive index of the first substrate by 0.1 or more.
(4) In an embodiment of the present invention, the light guide plate includes the structure (1), (2), or (3), and the second substrate and the adhesive layer each have a refractive index of 1.7 or higher.
(5) In an embodiment of the present invention, the light guide plate includes the structure (1), (2), (3), or (4), and a difference between the refractive index of the second substrate and a refractive index of the adhesive layer is 0.2 or less.
(6) In an embodiment of the present invention, the light guide plate includes the structure (1), (2), (3), (4), or (5), and the polymerized liquid crystal layer includes a portion constituting the diffractive element and a portion not constituting the diffractive element.
(7) In an embodiment of the present invention, the light guide plate includes the structure (1), (2), (3), (4), (5), or (6), and includes the diffractive element including at least a portion of the polymerized liquid crystal layer, and another diffractive element disposed between the adhesive layer and the second substrate.
(8) In an embodiment of the present invention, the light guide plate includes the structure (1), (2), (3), (4), (5), (6), or (7), and in a plan view, the second substrate is smaller than the first substrate.
(9) In an embodiment of the present invention, the light guide plate includes the structure (8), and in a plan view, an outer edge of the second substrate is positioned inward relative to an outer edge of the first substrate
(10) Another embodiment of the present invention relates to an AR display device including: the light guide plate including the structure (1), (2), (3), (4), (5), (6), (7), (8), or (9); and a display module facing the light guide plate.
(11) In an embodiment of the present invention, the AR display device includes the structure (10), the polymerized liquid crystal layer includes a portion constituting an input diffractive element in the diffractive element, a portion constituting an output diffractive element in the diffractive element, and a portion not constituting the diffractive element, and the display module faces the portion constituting the input diffractive element.

The present disclosure can provide a light guide plate and an AR display device that can be mass-produced and achieve a wide viewing angle.

### BRIEF DESCRIPTION OF THE DRAWINGS

FIG. 1 is a schematic view illustrating a method of producing a light guide plate of Embodiment 1.

FIG. 2 is a schematic cross-sectional view of the light guide plate of Embodiment 1.

FIG. 3 is a schematic cross-sectional view of a conventional AR light guide plate.

FIG. 4 is a graph showing the relationship between the refractive indices of components constituting an AR light guide plate and the viewing angle.

FIG. 5 is a schematic cross-sectional view of a light guide plate of Modification 1 of Embodiment 1.

FIG. 6 is a schematic cross-sectional view of a light guide plate of Modification 2 of Embodiment 1.

FIG. 7 is a schematic cross-sectional view of an AR display device of Embodiment 2.

FIG. 8 is a schematic cross-sectional view of a light guide plate of Comparative Example 1.

FIG. 9 is a schematic cross-sectional view illustrating the viewing angle of the light guide plate of Comparative Example 1.

FIG. 10 is a schematic cross-sectional view illustrating the viewing angle of a light guide plate of Comparative Example 2.

FIG. 11 is a schematic view illustrating a method of producing a light guide plate of Comparative Example 3.

FIG. 12 is a schematic cross-sectional view illustrating a method of evaluating the light guide plate of Comparative Example 3.

FIG. 13 is a display image from a projector in the evaluation of the light guide plate of Comparative Example 3.

FIG. 14 is an image emitted from the light guide plate of Comparative Example 3.

FIG. 15 is a schematic cross-sectional view of a first sample examined in the viewing angle evaluation of light guide plates of Examples 1-1 to 1-3.

FIG. 16 is a schematic cross-sectional view of a second sample examined in the viewing angle evaluation of the light guide plates of Examples 1-1 to 1-3.

FIG. 17 is a schematic cross-sectional view illustrating the minimum viewing angle of the light guide plates of Examples 1-1 to 1-3.

FIG. 18 is a schematic cross-sectional view illustrating the maximum viewing angle of the light guide plates of Examples 1-1 to 1-3.

FIG. 19 is a schematic view illustrating a method of producing a light guide plate of Example 3.

FIG. 20 is a schematic cross-sectional view of a light guide plate of a reference example.

FIG. 21 is an image emitted from the light guide plate of Example 3.

FIG. 22 is an image emitted from the light guide plate of the reference example.

FIG. 23 schematically shows an image for measuring luminance distribution.

FIG. 24 shows the results of luminance distribution measurement when red light is displayed.

FIG. 25 shows the results of luminance distribution measurement when green light is displayed.

FIG. 26 shows the results of luminance distribution measurement when blue light is displayed.

### DETAILED DESCRIPTION

Hereinafter, embodiments of the present invention will be described. The present invention is not limited to the following embodiments, and various modifications may be made as appropriate within the scope of the configuration of the present invention. In the following description, identical or functionally similar components are denoted by the same reference signs across different figures, and repeated descriptions thereof are omitted as appropriate. The embodiments of the present invention may be combined as appropriate without departing from the gist of the present invention.

### Embodiment 1

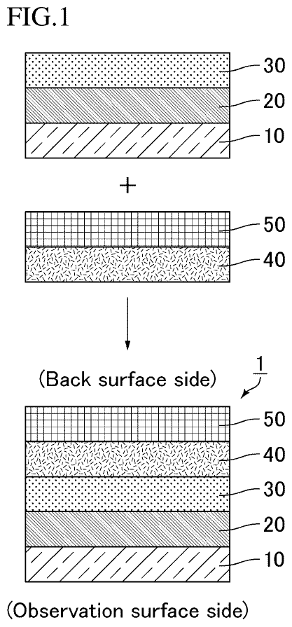

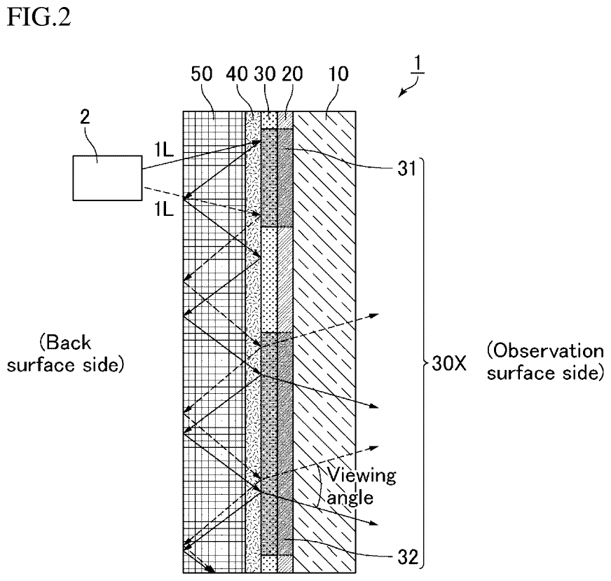

FIG. 1 is a schematic view illustrating a method of producing a light guide plate of Embodiment 1. FIG. 2 is a schematic cross-sectional view of the light guide plate of Embodiment 1. As shown in FIG. 1 and FIG. 2, a light guide plate (specifically, an augmented reality (AR) light guide plate) 1 of the present embodiment sequentially includes a first substrate 10, a photoalignment film 20, a polymerized liquid crystal layer 30 containing a cured product of a polymerizable liquid crystal, an adhesive layer 40, and a second substrate 50 having a different refractive index from the first substrate 10, and the light guide plate 1 further includes a diffractive element 30X.

The augmented reality (AR) light guide plate using a polarization volume grating (PVG) method, a diffractive element employing periodically aligned liquid crystal molecules, can be produced using existing mass-production facilities for liquid crystal technologies. Therefore, such an AR light guide plate is expected to be more suitable for mass production than an AR light guide plate using a surface relief grating (SRG) method, a diffractive element employing a periodic surface-relief structure. Furthermore, in order to fabricate a light guide plate with a wide viewing angle, the constituent components (substrate, photoalignment film, polymerizable liquid crystal) are required to have a high refractive index.

However, fabricating large mother glass with a high-refractive-index substrate is difficult, and existing facilities cannot easily be used for this purpose. Therefore, this approach does not lead to mass production. On the other hand, mother glass compatible with existing facilities can be prepared using a low-refractive-index substrate. However, due to the low refractive index of the substrate, the viewing angle may undesirably become narrower.

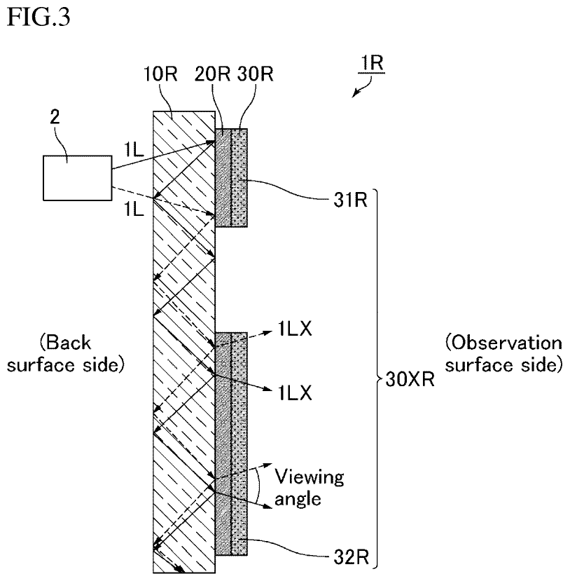

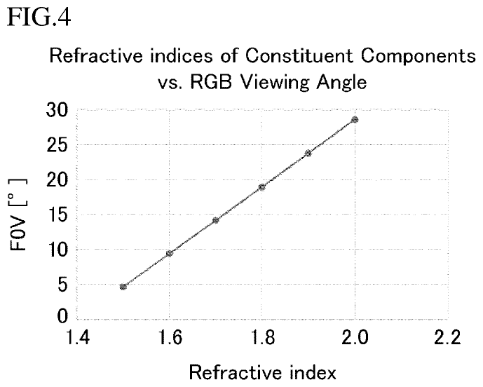

FIG. 3 is a schematic cross-sectional view of a conventional AR light guide plate. FIG. 4 is a graph showing the relationship between the refractive indices of components constituting an AR light guide plate and the viewing angle. A conventional AR light guide plate 1R sequentially includes, as shown in FIG. 3, a first substrate 10R, a photoalignment film 20R, and a polymerized liquid crystal layer 30R containing a cured product of a polymerizable liquid crystal. The polymerized liquid crystal layer 30R includes a diffractive element 30XR which includes a light incidence section 31R configured to cause light (also referred to as image light) 1L incident from the first substrate 10R side (back surface side) to enter the first substrate 10R, and a light emission section 32R configured to emit the light 1L as emission light 1LX toward the side opposite the first substrate 10R (toward the observation surface side, i.e., the outside). As shown in FIG. 4, the higher the refractive indices of the components constituting the AR light guide plate 1R are, the wider the viewing angle becomes.

As shown in FIG. 1 and FIG. 2, the light guide plate (specifically, AR light guide plate) 1 of the present embodiment sequentially includes the first substrate 10, the photoalignment film 20, the polymerized liquid crystal layer 30 containing a cured product of a polymerizable liquid crystal, the adhesive layer 40, and the second substrate 50 having a different refractive index from the first substrate 10, and the light guide plate 1 also includes the diffractive element 30X. Such a light guide plate 1 can have a structure in which on the light guide plate with a low-refractive-index substrate (e.g., first substrate 10), a high-refractive-index substrate (e.g., second substrate 50) is disposed via the adhesive layer 40 having a high refractive index, thereby achieving a wide viewing angle. In addition, employing a low-refractive-index substrate (first substrate 10), the light guide plate 1 of the present embodiment can be produced using existing facilities, achieving mass production. Thereby, the light guide plate 1 with a wide viewing angle can be mass-produced.

The light guide plate for image display disclosed in JP 2024-161574 A is a laminate of substrates having the same refractive index. In contrast, the light guide plate 1 of the present embodiment is a laminate of substrates having different refractive indices, meaning that it has a different structure from the light guide plate disclosed in JP 2024-161574 A.

Hereinafter, the light guide plate 1 of the present embodiment will be described in detail.

The light guide plate 1 of the present embodiment includes the diffractive element 30X. The diffractive element 30X includes a light incidence section 31 configured to cause light (also referred to as image light) 1L incident from the second substrate 50 side (back surface side) to enter the second substrate 50, and a light emission section 32 configured to emit the light 1L toward the side opposite the second substrate 50 (toward the observation surface side, i.e., the outside). In this embodiment, the light guide plate 1 can use the diffractive element 30X to diffract the light 1L incident from the back surface side and then emit the diffracted light 1L toward the observation surface side, achieving a wide viewing angle.

Preferably, the light guide plate 1 of the present embodiment includes, sequentially from the observation surface side toward the back surface side, the first substrate 10, the photoalignment film 20, the polymerized liquid crystal layer 30, the adhesive layer 40, and the second substrate 50. This embodiment can improve the optical characteristics, ensure the reliability, and protect the film surface.

The light guide plate 1 of the present embodiment can be produced by attaching the portion (semi-finished light guide plate 1) including the first substrate 10, the photoalignment film 20, and the polymerized liquid crystal layer 30 of the light guide plate 1 to the second substrate 50 having a high refractive index via the adhesive layer 40. This can reduce the cost of mass production.

The first substrate 10 is preferably an insulating substrate. The first substrate 10 is preferably transparent. The term “transparent” means that the total light transmittance defined in JIS7361-1 (ISO13468-1) is 85% or higher.

Examples of the first substrate 10 include insulating substrates such as glass substrates and plastic substrates. Examples of the material of the glass substrates include glass such as float glass and soda-lime glass. Examples of the material of the plastic substrates include plastics such as polyethylene terephthalate, polybutylene terephthalate, polyethersulfone, polycarbonate, and alicyclic polyolefin.

The first substrate 10 preferably has a refractive index lower than 1.6. In this embodiment, the portion (semi-finished light guide plate 1) including the first substrate 10, the photoalignment film 20, and the polymerized liquid crystal layer 30 of the light guide plate 1 can be produced using large mother glass (a plurality of regions are formed on the mother glass to use each region as a first substrate 10, so that a plurality of semi-finished light guide plates 1 can be produced from one sheet of mother glass), which allows for lower-cost mass production. Additionally, the second substrate 50 having a high refractive index is attached to the polymerized liquid crystal layer 30 side of the semi-finished light guide plate 1 via the adhesive layer 40 to obtain the light guide plate 1, so that the light guide plate 1 with a wide viewing angle can be mass-produced at a reduced cost. The first substrate 10 more preferably has a refractive index of 1.5 or lower. The lower limit of the refractive index of the first substrate 10 is not limited, but the first substrate 10 has a refractive index of 1.2 or higher, for example.

The photoalignment film 20 can be obtained, for example, by forming a film of an alignment film material containing a photoalignment polymer with a photo-functional group on a substrate. An alignment treatment is performed on the photoalignment film 20. For example, the alignment treatment is performed by irradiating the photoalignment film 20 containing a photoalignment polymer with polarized ultraviolet light (also referred to as polarized UV or PUV) to induce anisotropy on the surface of the photoalignment film 20.

The thickness of the photoalignment film 20 is preferably 10 nm or greater and 100 nm or less. Here, in a light guide plate in which a photoalignment film is interposed between a high-refractive-index substrate and a polymerized liquid crystal layer, the viewing angle depends on the refractive index of the photoalignment film when the photoalignment film has a large thickness (e.g., 10 nm or greater). Specifically, when the photoalignment film has a lower refractive index than the high-refractive-index substrate, the viewing angle may possibly be reduced. The reduction of the viewing angle may be suppressed, for example, by methods including using a high-refractive-index material for the photoalignment film or setting the thickness of the photoalignment film to a small value (e.g., 10 nm or less). In contrast, the present embodiment can employ a configuration in which no photoalignment film 20 is interposed between the second substrate 50 having a high refractive index and the polymerized liquid crystal layer 30 when the second substrate 50 has a higher refractive index than the first substrate 10. Thus, in the light guide plate 1 of the present embodiment, a wide viewing angle can be achieved even when the thickness of the photoalignment film 20 is 10 nm or greater. Furthermore, when the thickness of the photoalignment film 20 is 10 nm or greater, the photoalignment film 20 can be easily produced. When the thickness of the photoalignment film 20 is 100 nm or less, light absorption by the photoalignment film 20 itself can be suppressed, which can suppress deterioration in the performance of the light guide plate 1.

Examples of the photoalignment polymer include photoalignment polymers containing at least one photo-functional group selected from the group consisting of cyclobutane, azobenzene, chalcone, cinnamate, coumarin, stilbene, phenol ester, and phenyl benzoate groups. The photoalignment polymer contained in the photoalignment film may be one kind or two kinds or more. The photo-functional group contained in the photoalignment polymer may be located in the main chain, in a side chain, or in both of the main chain and a side chain of the polymer.

Preferred examples of the photoalignment polymer include photodegradable polymers, photo-rearranging polymers (preferably, photo-Fries rearranging polymers), photoisomerizable polymers, photodimerizable polymers, and photo-crosslinking polymers. Any of these may be used alone or in combination of two or more thereof. In terms of the alignment stability, particularly preferred among these are a photodegradable polymer having a reaction wavelength (main sensitive wavelength) around 254 nm and a photo-rearranging polymer having a reaction wavelength (main sensitive wavelength) around 254 nm. Also preferred are a photoisomerizable polymer containing a photo-functional group in a side chain and a photodimerizable polymer containing a photo-functional group in a side chain. The photoalignment polymer preferably has a main chain structure including at least one structure selected from a polyamic acid structure, a polyimide structure, a poly(meth)acrylic acid structure, a polysiloxane structure, a polyethylene structure, a polystyrene structure, and a polyvinyl structure.

The polymerized liquid crystal layer 30 contains a cured product of a polymerizable liquid crystal (reactive mesogen). The polymerizable liquid crystal is preferably a photopolymerizable liquid crystal which is cured when irradiated with light.

The polymerized liquid crystal layer 30 is formed, for example, by applying a polymerizable liquid crystal and then curing the polymerizable liquid crystal. Examples of the polymerizable liquid crystal include liquid crystal polymers (liquid crystalline polymers) having a photo-reactive group. Examples of the polymerizable liquid crystal include polymers having both a substituent (mesogen group) and a photoreactive group in their side chains and having an acrylate, methacrylate, maleimide, N-phenylmaleimide, siloxane, or other structure in their main chains. The substituent may be a biphenyl group, a terphenyl group, a naphthalene group, a phenylbenzoate group, an azobenzene group, or a derivative of any of these groups. The photoreactive group may be a cinnamoyl group, a chalcone group, a cinnamylidene group, a β-(2-phenyl) acryloyl group, a cinnamic acid group, or a derivative of any of these groups. The polymer may be a homopolymer consisting of a single repeat unit or may be a copolymer consisting of two or more repeat units different in side chain structure. The copolymer encompasses all of alternating copolymers, random copolymers, and graft copolymers. In the copolymer, a side chain of at least one repeat unit has a structure including both the mesogen group and the photoreactive group, and a side chain of any other repeat unit may not have the mesogen group or the photoreactive group.

The polymerizable liquid crystal may contain additives such as a photopolymerization initiator. Non-limiting examples of the photopolymerization initiator include conventionally known ones.

Examples of the solvent used for the polymerizable liquid crystal include toluene, ethylbenzene, ethylene glycol monomethyl ether, ethylene glycol dimethyl ether, propylene glycol methyl ether, dibutyl ether, acetone, methyl ethyl ketone, ethanol, propanol, cyclohexane, cyclopentanone, methylcyclohexane, tetrahydrofuran, dioxane, cyclohexanone, n-hexane, ethyl acetate, butyl acetate, propylene glycol methyl ether acetate, methoxy butyl acetate, N-methyl pyrrolidone, and dimethylacetamide. Any of these may be used alone or two or more of these may be used in combination.

The polymerized liquid crystal layer 30 includes portions constituting the diffractive element 30X and a portion not constituting the diffractive element 30X. The polymerized liquid crystal layer 30 is positioned directly or indirectly on substantially the entire surface of the first substrate 10, for example. One portion of the polymerized liquid crystal layer 30 serves as a portion constituting the light incidence section 31 (input diffractive element), another portion serves as a portion constituting the light emission section 32 (output diffractive element), and the remaining portion serves as a portion not constituting the diffractive element 30X. The portion constituting the light incidence section 31and the portion constituting the light emission section 32 are each continuous with the portion not constituting the diffractive element 30X. This embodiment enables secure attachment of the second substrate 50 having a high refractive index to the polymerized liquid crystal layer 30 side of the semi-finished light guide plate 1 via the adhesive layer 40. The embodiment can also reduce loss of light emitted from the projector 2, thereby increasing the amount of light extractable from the light emission section 32 (output diffractive element). In other words, the embodiment can improve the light use efficiency. The polymerized liquid crystal layer 30 including the portions constituting the diffractive element 30X and the portion not constituting the diffractive element 30X can be obtained by, for example, exposing the photoalignment film 20 through a mask. In other words, in the present embodiment, the polymerized liquid crystal layer 30 including the portions constituting the diffractive element 30X and the portion not constituting the diffractive element 30X can be obtained by patterning the alignment direction of the polymerizable liquid crystal by the mask exposure.

The adhesive layer 40 is, for example, an optically clear adhesive (OCA). The thickness of the adhesive layer 40 is preferably 1 μm or greater and 100 μm or less. When the thickness of the adhesive layer 40 is 1 μm or greater, the number of total internal reflections within the light guide plate 1 can be reduced, which enables reduction of light loss, thereby reducing darkening of the display image. When the thickness of the adhesive layer 40 is 100 μm or less, the distance between successive total internal reflections inside the light guide plate 1 can be reduced, so that the occurrence of dark lines (areas where the display image cannot be seen) within the range of the light emission section 32 (output diffractive element) can be reduced. The thickness of the adhesive layer 40 is more preferably 3 μm or greater and 80 μm or less.

The adhesive layer 40 preferably has a higher refractive index than the first substrate 10. In this embodiment, the light guide plate 1 can effectively achieve a wide viewing angle. The adhesive layer 40 preferably has a refractive index that is higher than the refractive index of the first substrate 10 by 0.1 or more, more preferably by 0.2 or more.

The refractive index of the adhesive layer 40 can be adjusted, for example, by a known method disclosed in a patent publication.

The adhesive layer 40 preferably has a refractive index of 1.6 or higher. In this embodiment, the light guide plate 1 can effectively achieve a wide viewing angle. The adhesive layer 40 more preferably has a refractive index of 1.7 or higher, still more preferably 1.8 or higher. The upper limit of the refractive index of the adhesive layer 40 is not limited, but the adhesive layer 40 has a refractive index of 2.0 or lower, for example.

The second substrate 50 is preferably an insulating substrate. The second substrate 50 is preferably transparent. The term “transparent” means that the total light transmittance defined in JIS7361-1 (ISO13468-1) is 85% or higher. The thickness of the second substrate 50 is preferably 0.3 mm or greater and 1 mm or less. When the thickness of the second substrate 50 is 0.3 mm or greater, the number of total internal reflections within the light guide plate 1 can be reduced, which enables reduction of light loss, thereby reducing darkening of the display image. When the thickness of the second substrate 50 is 1 mm or less, the weight of the light guide plate 1 can be reduced. Furthermore, the distance between successive total internal reflections inside the light guide plate 1 can be reduced, so that the occurrence of dark lines (areas where the display image cannot be seen) within the range of the light emission section 32 (output diffractive element) can be reduced. The thickness of the second substrate 50 is more preferably 0.5 mm or greater and 0.7 mm or less.

Examples of the second substrate 50 include insulating substrates such as glass substrates and plastic substrates. Examples of the material of the glass substrates include glass such as float glass and soda-lime glass. Examples of the material of the plastic substrates include plastics such as polyethylene terephthalate, polybutylene terephthalate, polyethersulfone, polycarbonate, and alicyclic polyolefin.

The second substrate 50 has a different refractive index from the first substrate 10. Such a light guide plate 1 can have a structure in which on the light guide plate with a low-refractive-index substrate (e.g., first substrate 10), a high-refractive-index substrate (e.g., second substrate 50) is disposed via the adhesive layer 40 having a high refractive index, thereby achieving a wide viewing angle.

The second substrate 50 preferably has a higher refractive index than the first substrate 10. In this embodiment, the light guide plate 1 can effectively achieve a wide viewing angle. The second substrate 50 preferably has a refractive index that is higher than the refractive index of the first substrate 10 by 0.1 or more, more preferably by 0.2 or more. The refractive index of a substrate such as the first substrate 10 or the second substrate 50 can be adjusted, for example, by a known method disclosed in a patent publication.

The second substrate 50 preferably has a refractive index of 1.6 or higher. In this embodiment, the light guide plate 1 can effectively achieve a wide viewing angle. The second substrate 50 more preferably has a refractive index of 1.7 or higher, still more preferably 1.8 or higher. The upper limit of the refractive index of the second substrate 50 is not limited, but the second substrate 50 has a refractive index of 2.0 or lower, for example.

The second substrate 50 and the adhesive layer 40 each have a higher refractive index than the first substrate 10. In this embodiment, the light guide plate 1 can more effectively achieve a wide viewing angle. The second substrate 50 and the adhesive layer 40 each preferably have a refractive index that is higher than the refractive index of the first substrate 10 by 0.1 or more, more preferably by 0.2 or more.

The second substrate 50 and the adhesive layer 40 each preferably have a refractive index of 1.7 or higher. In this embodiment, the light guide plate 1 can more effectively achieve a wide viewing angle.

The difference between the refractive index of the second substrate 50 and the refractive index of the adhesive layer 40 is preferably 0.2 or less. In this embodiment, the light guide plate 1 can more effectively achieve a wide viewing angle. The difference between the refractive index of the second substrate 50 and the refractive index of the adhesive layer 40 is more preferably 0.1 or less. Still more preferably, the second substrate 50 and the adhesive layer 40 have the same refractive index.

### Modification 1 of Embodiment 1

FIG. 5 is a schematic cross-sectional view of a light guide plate of Modification 1 of Embodiment 1. As shown in FIG. 5, the light guide plate 1 may include the diffractive element 30X including at least a portion of the polymerized liquid crystal layer 30, and another diffractive element (specifically, diffractive element 30XN) disposed between the adhesive layer 40 and the second substrate 50. In this embodiment, as shown in FIG. 5, light that passes through the first diffractive element (diffractive element 30XN) is further diffracted by the second diffractive element (diffractive element 30X), increasing the amount of light that undergoes total internal reflection. In other words, stacking two diffractive elements together can improve the light use efficiency.

The light guide plate 1 of the present modification includes, for example, a polymerized liquid crystal layer (also referred to as a second substrate-side polymerized liquid crystal layer) 30N disposed on the side of the adhesive layer 40 facing the second substrate 50, and a photoalignment film (also referred to as a second substrate-side photoalignment film) 20N disposed on the side of the polymerized liquid crystal layer 30N facing the second substrate 50. The photoalignment film 20N and the polymerized liquid crystal layer 30N have the same structures as the photoalignment film 20 and the polymerized liquid crystal layer 30, respectively.

The polymerized liquid crystal layer 30N is disposed directly or indirectly on substantially the entire surface of the first substrate 10, for example. One portion of the polymerized liquid crystal layer 30N serves as a portion constituting a light incidence section 31N (input diffractive element, also referred to as a second substrate-side light incidence section), another portion serves as a portion constituting a light emission section 32N (output diffractive element, also referred to as a second substrate-side light emission section), and the remaining portion serves as a portion not constituting the diffractive element 30XN. The portion constituting the light incidence section 31N and the portion constituting the light emission section 32N are each continuous with the portion not constituting the diffractive element 30XN. The light incidence section 31N and the light emission section 32N have the same structures as the light incidence section 31 and the light emission section 32, respectively.

### Modification 2 of Embodiment 1

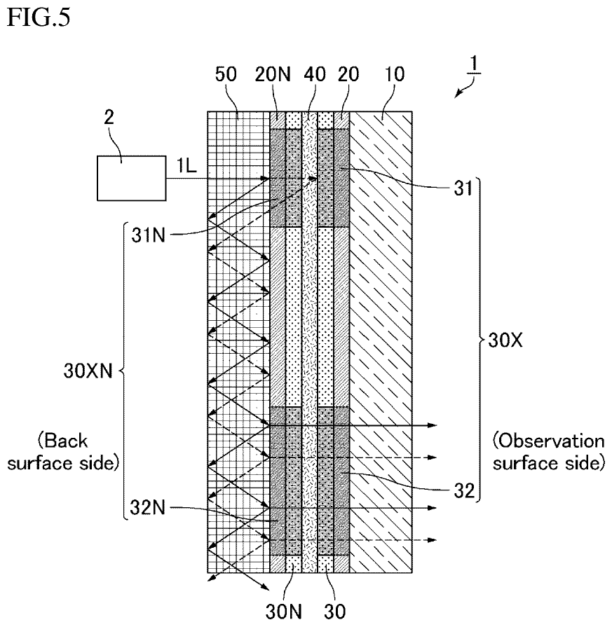

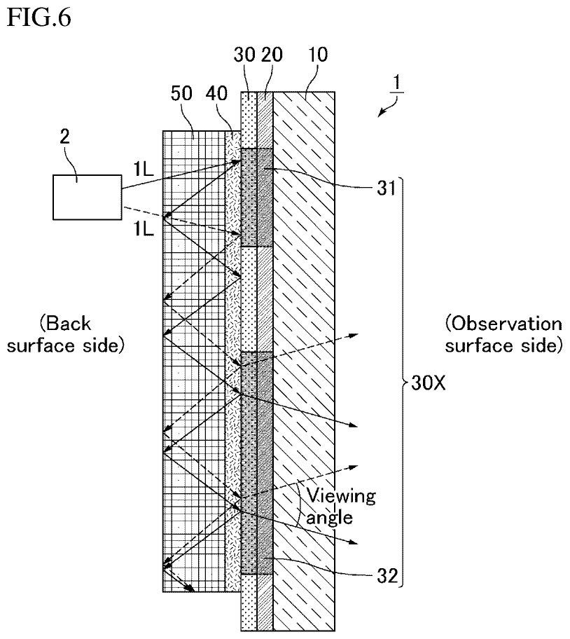

FIG. 6 is a schematic cross-sectional view of a light guide plate of Modification 2 of Embodiment 1. In a plan view, the second substrate 50 may be smaller than the first substrate 10. In this embodiment in which the high-refractive-index substrate (e.g., second substrate 50) is made smaller than the low-refractive-index substrate (e.g., first substrate 10), the total cost can be reduced.

In a plan view, the outer edge of the second substrate 50 is located inward relative to the outer edge of the first substrate 10. In this embodiment in which the high-refractive-index substrate (e.g., second substrate 50) is made smaller than the low-refractive-index substrate (e.g., first substrate 10), as in the embodiment above, the total cost can be reduced.

### Embodiment 2

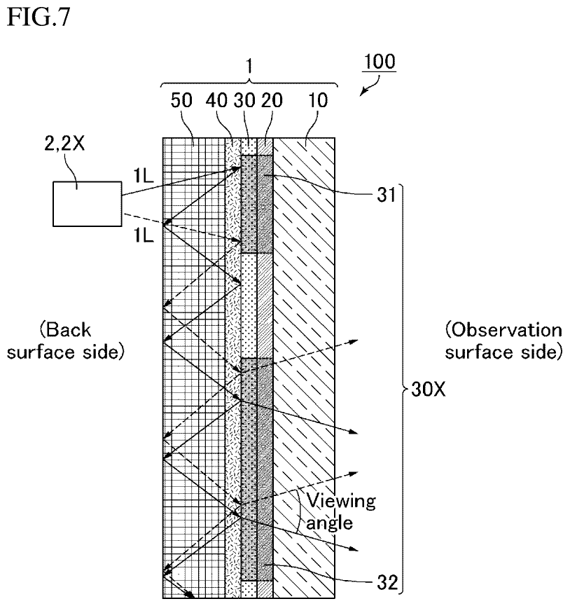

FIG. 7 is a schematic cross-sectional view of an AR display device of Embodiment 2. As shown in FIG. 7, an AR display device 100 of the present embodiment includes the light guide plate 1 and a display module 2X facing the light guide plate 1. The AR display device 100 is a display device that displays content compatible with augmented reality (AR) technology. The AR display device 100 uses the light guide plate 1 to enable the user to view images from the display module 2X overlaid on the real-world view.

The display module 2X has an image-display function. The display module 2X is, for example, a projector 2.

The polymerized liquid crystal layer 30 includes a portion constituting an input diffractive element (light incidence section 31) in the diffractive element 30X, a portion constituting an output diffractive element (light emission section 32) in the diffractive element 30X, and a portion not constituting the diffractive element 30X. The display module 2X faces the portion constituting the input diffractive element (light incidence section 31). In this embodiment, the display quality of images to be viewed can be improved.

Although the display module 2X is disposed on the back surface side of the light guide plate 1 in FIG. 7, the display module 2X may be disposed on the observation surface side of the light guide plate 1 (the side of the first substrate 10 opposite the second substrate 50)

### EXAMPLES

Hereinafter, examples and comparative examples will be described. The present invention is not limited to these examples.

### Comparative Example 1

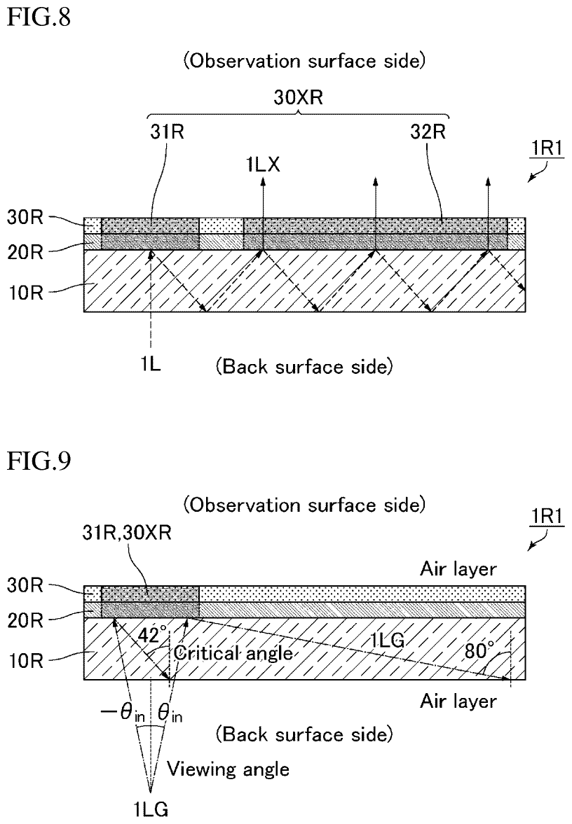

FIG. 8 is a schematic cross-sectional view of a light guide plate of Comparative Example 1. The below-described properties of a light guide plate 1R1 of Comparative Example 1 shown in FIG. 8 were examined. The light guide plate 1R1 of Comparative Example 1 sequentially included a first substrate 10R, a photoalignment film 20R, and a polymerized liquid crystal layer 30R containing a cured product of a polymerizable liquid crystal.

The first substrate 10R, the photoalignment film 20R, and the polymerized liquid crystal layer 30R each had a refractive index of 1.5. The first substrate 10R had a light-guiding function. On the photoalignment film 20R having a diffraction pattern, the polymerized liquid crystal layer 30R with the polymerized liquid crystal molecules aligned in the same pattern was disposed to constitute the diffractive element 30XR. The diffractive element 30XR included a light incidence section 31R configured to cause light 1L incident from the first substrate 10R side (back surface side) to enter the first substrate 10R, and a light emission section 32R configured to emit the light 1L as emission light 1LX toward the side opposite the first substrate 10R (toward the observation surface side, i.e., the outside).

### <Viewing Angle Evaluation for Green Display (Green Light)>

FIG. 9 is a schematic cross-sectional view illustrating the viewing angle of the light guide plate of Comparative Example 1. For the light guide plate of Comparative Example 1 whose components, i.e., the first substrate 10R, the photoalignment film 20R, and the polymerized liquid crystal layer 30R, each had a refractive index of 1.5, the viewing angle of green light 1LG (wavelength: 532 nm) was calculated using the grating equation. The air layer was assumed to have a refractive index of 1.0. The grating equation is expressed as follows.

$${n}_{out} sin {θ}_{out} = \frac{m λ}{Λ} + {n}_{i n} sin {θ}_{i n} \qquad ( Equation 1 )$$

In Equation (1), nₒᵤₜ represents the refractive index of the first substrate, θₒᵤₜ represents the emission angle (angle after diffraction), m represents the diffraction order, λ represents the wavelength of incident light, Λ represents the pitch of the diffractive element, nᵢₙ represents the refractive index of the air layer, and θᵢₙ represents the incidence angle.

As shown in FIG. 9, in order to guide the green light 1LG within the first substrate 10R, the angle of the green light 1LG, after being diffracted within the light guide plate 1R1, needs to be equal to or greater than the critical angle for emission of the green light 1LG from the first substrate 10R into the air layer. Therefore, the minimum angle at which the green light 1LG is guided within the first substrate 10R having a refractive index of 1.5 was 42° (=arc·sin(1.0/1.5)≈41.810). When the angle after diffraction reaches a specific value, the green light 1LG travels parallel to the first substrate 10R instead of undergoing total internal reflection within the first substrate 10R. Therefore, the maximum angle after diffraction for guiding light was set to 80°.

The wavelength of the incident green light 1LG, which was 532 nm, and the minimum angle and the maximum angle for guiding the green light 1LG within the first substrate 10R, which were 42° and 80°, respectively, were substituted into the grating equation. As a result, equation (2) and equation (3) below were obtained.

$$sin ( - θ ) + \frac{532}{Λ} = 1.5 \times sin 42 ° = 1 \qquad ( Equation 2 )$$

$$sin ( + θ ) + \frac{532}{Λ} = 1.5 \times sin 80 ° \qquad ( Equation 3 )$$

In equation (2) and the equation (3), Λ represents the pitch of the diffractive element.

When the θ obtained from equation (2) and the θ obtained from equation (3) are symmetric, i.e., when the absolute values of these θ values are equal and their signs are opposite, the pitch Λ of the diffractive element can be determined. Additionally, as shown in FIG. 9, “θ×2” results in the viewing angle.

The thus-obtained viewing angle of the light guide plate 1R1 of Comparative Example 1 was 28°. The detailed calculation results are shown in equation (4) and equation (5) below. Equation (4) below shows the calculation results when the minimum angle for guiding the green light 1LG within the first substrate 10R was assumed to be 42°. Equation (5) below shows the calculation results when the minimum angle for guiding the green light 1LG within the first substrate 10R was assumed to be 41.810°. The viewing angle obtained from equation (4) below was 27.391°. The viewing angle obtained from equation (5) below was 27.609°

$$\begin{matrix}sin ( θ ) = ( 1.5 \times sin 80 ° - 1.5 \times sin 42 ° ) / 2 & \approx & 0.237 \\ θ & \approx & 13.695 \\ Λ = 532 / ( 1.5 \times sin 42 ° + sin ( θ ) ) & \approx & 428.875 \\ = 532 / ( 1.5 \times sin 80 ° - sin ( θ ) ) & \approx & 428.875\end{matrix} \qquad ( Equation 4 )$$

$$\begin{matrix}sin ( θ ) = ( 1.5 \times sin 80 ° - 1.5 \times sin 42 ° ) / 2 & \approx & 0.239 \\ θ & \approx & 13.804 \\ Λ = 532 / ( 1.5 \times sin 42 ° + sin ( θ ) ) & \approx & 429.515 \\ = 532 / ( 1.5 \times sin 80 ° - sin ( θ ) ) & \approx & 429.515\end{matrix} \qquad ( Equation 4 )$$

### Comparative Example 2

### <RGB Viewing Angle Evaluation>

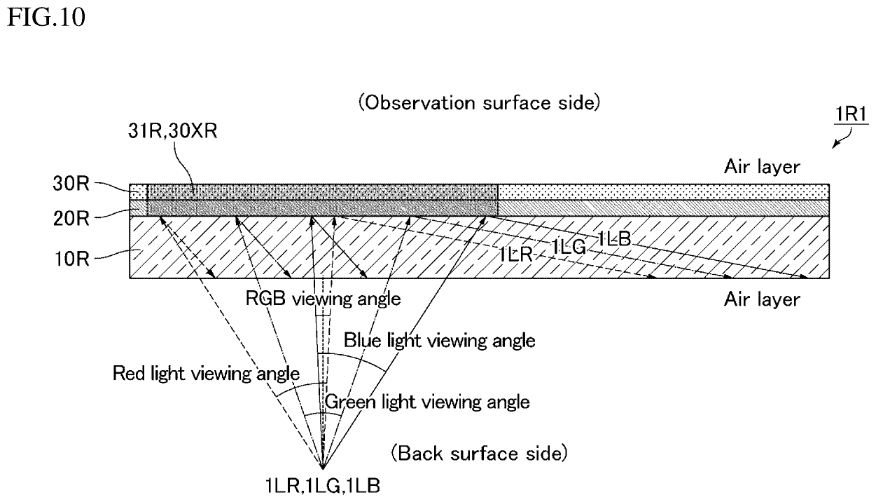

FIG. 10 is a schematic cross-sectional view illustrating the viewing angle of a light guide plate of Comparative Example 2. In Comparative Example 2, the viewing angles for red light 1LR (620 nm) and blue light 1LB (450 nm) were calculated using the same calculation method as that in Comparative Example 1, using the light guide plate 1R1 of Comparative Example 1 based on the pitch A obtained in Comparative Example 1. Table 1 below shows the results.

TABLE 1

| | Wavelength | | |
|---|---|---|---|
| | 450 nm | 532 nm | 620 nm |
| Minimum viewing | −3 | −14 | −26 |
| angle [°] | | | |
| Maximum viewing | 25 | 14 | 2 |
| angle [°] | | | |

The detailed calculation results relating to Table 1 are shown in equation (6), equation (7), Table 2, and Table 3 below. Equation (6) and Table 2 below show the calculation results when the minimum angle for guiding light within the first substrate 10R was assumed to be 42°. Equation (7) and Table 3 below show the calculation results when the minimum angle for guiding light within the first substrate 10R was assumed to be 41.810°.

$$\begin{matrix}Blue light : sin ( - θ ) = 1.5 \times sin 42 ° - \frac{450}{Λ} & \approx & - 0.046 \\ Blue light : - θ & \approx & - 2.611 \\ Blue light : sin ( + θ ) = 1.5 \times sin 80 ° - \frac{450}{Λ} & \approx & 0.428 \\ Blue light : + θ & \approx & 25.338 \\ Red light : sin ( - θ ) = 1.5 \times sin 42 ° - \frac{620}{Λ} & \approx & - 0.442 \\ Red light : - θ & \approx & - 26.228 \\ Red light : sin ( + θ ) = 1.5 \times sin 80 ° - \frac{620}{Λ} & \approx & 0.032 \\ Red light : + θ & \approx & 1.809\end{matrix} \qquad ( Equation 6 )$$

TABLE 2

| | Wavelength | | |
|---|---|---|---|
| | 450 nm | 532 nm | 620 nm |
| Minimum viewing | −2.611 | −13.695 | −26.228 |
| angle [°] | | | |
| Maximum viewing | 25.338 | 13.695 | 1.809 |
| angle [°] | | | |

$$\begin{matrix}Blue light : sin ( - θ ) = 1.5 \times sin 42 ° - \frac{450}{Λ} & \approx & - 0.048 \\ Blue light : - θ & \approx & - 2.734 \\ Blue light : sin ( + θ ) = 1.5 \times sin 80 ° - \frac{450}{Λ} & \approx & 0.43 \\ Blue light : + θ & \approx & 25.437 \\ Red light : sin ( - θ ) = 1.5 \times sin 42 ° - \frac{620}{Λ} & \approx & - 0.443 \\ Red light : - θ & \approx & - 26.327 \\ Red light : sin ( + θ ) = 1.5 \times sin 80 ° - \frac{620}{Λ} & \approx & 0.034 \\ Red light : + θ & \approx & 1.933\end{matrix} \qquad ( Equation 7 )$$

TABLE 3

| | Wavelength | | |
|---|---|---|---|
| | 450 nm | 532 nm | 620 nm |
| Minimum viewing | −2.734 | −13.804 | −26.327 |
| angle [°] | | | |
| Maximum viewing | 25.437 | 13.804 | 1.933 |
| angle [°] | | | |

Furthermore, the overlapping range of the viewing angles for the blue light 1LB (wavelength: 450 nm), the green light 1LG (532 nm), and the red light 1LR (620 nm) was determined and defined as the RGB viewing angle. Table 1 above shows that the overlapping range of all these colors is from −3° to 2°, and the RGB viewing angle was 5° when the refractive index of the constituent components was 1.5. Specifically, when a calculation was performed under the assumption that the minimum angle for guiding light within the first substrate 10R was 42°, the overlapping range of all the colors was from −2.611° to 1.809°, and the RGB viewing angle was 4.420° when the refractive index of the constituent components was 1.5. Also, when a calculation was performed on the assumption that the minimum angle for guiding light within the first substrate 10R was 41.810°, the overlapping range of all the colors was from −2.734° to 1.933°, and the RGB viewing angle was 4.666° when the refractive index of the constituent components was 1.5.

### Comparative Example 3

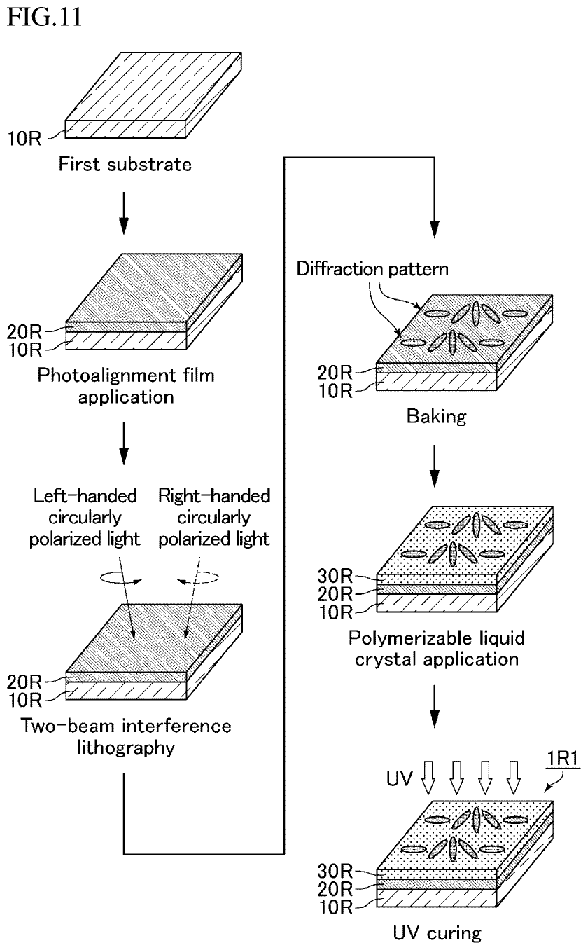

FIG. 11 is a schematic view illustrating a method of producing a light guide plate of Comparative Example 3. In Comparative Example 3, an actually produced light guide plate 1R1 was used to examine display images. The procedure of producing the light guide plate 1R1 of Comparative Example 3 is described below. As shown in FIG. 11, first, a photoalignment film 20R was formed on a first substrate 10R having a refractive index of 1.5 by spin coating, followed by two-beam interference lithography using right-handed circularly polarized light and left-handed circularly polarized light from a 355-nm laser. Subsequently, the workpiece was irradiated with UV light at 10 mJ/cm² and then baked on a 140° C. hot plate for 10 minutes, forming a diffraction pattern. Thereafter, a polymerizable liquid crystal (liquid crystalline acrylic monomers) was applied. The polymerizable liquid crystal was applied by spin coating to form a film with a thickness of 180 nm. After the polymerizable liquid crystal was applied, the polymerizable liquid crystal was cured using 2000 mJ of non-polarized UV light. Thereby, the light guide plate 1R1 of Comparative Example 3 was obtained.

### <Display Image Evaluation Method>

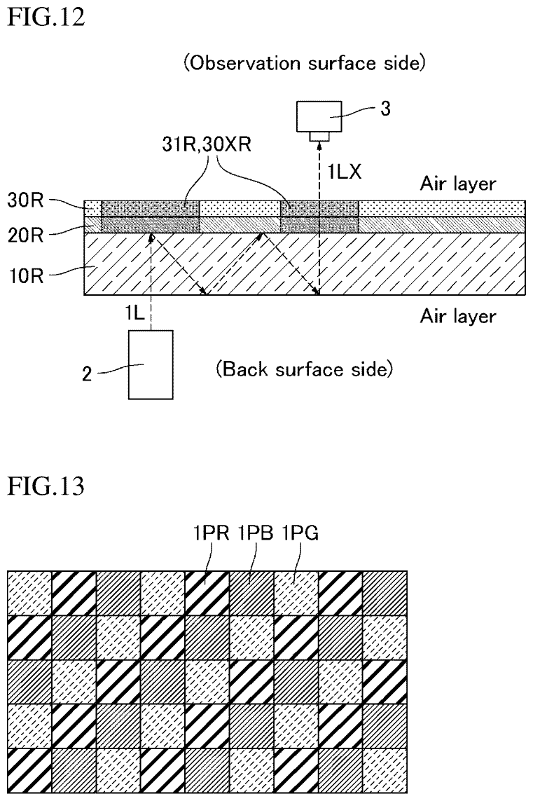

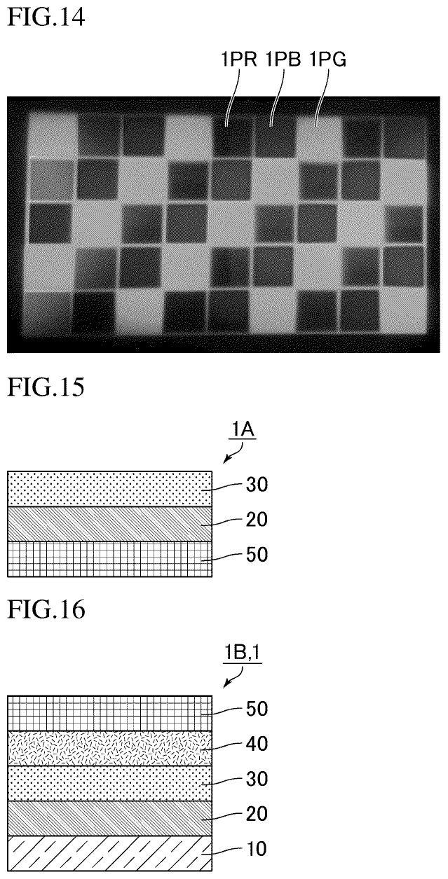

FIG. 12 is a schematic cross-sectional view illustrating a method of evaluating the light guide plate of Comparative Example 3. FIG. 13 is a display image from a projector in the evaluation of the light guide plate of Comparative Example 3. FIG. 14 is an image emitted from the light guide plate of Comparative Example 3.

As shown in FIG. 12, a display image from a projector 2 was incident on the first substrate 10R side of the produced light guide plate 1R1 of Comparative Example 3, and an image emitted from the surface of the polymerized liquid crystal layer 30R was captured by a camera 3. As shown in FIG. 13, in the display image from the projector 2, red elements 1PR, green elements 1PG, and blue elements 1PB were arranged in a staggered pattern. The image captured using the light guide plate 1R1 of Comparative Example 3 is shown in FIG. 14. FIG. 14 shows that the region where all of the red elements 1PR, the green elements 1PG, and the blue elements 1PB appear correctly is narrow.

### Examples 1-1 to 1-3

FIG. 15 is a schematic cross-sectional view of a first sample examined in the viewing angle evaluation of light guide plates of Examples 1-1 to 1-3. FIG. 16 is a schematic cross-sectional view of a second sample examined in the viewing angle evaluation of the light guide plates of Examples 1-1 to 1-3. To evaluate the viewing angle for green light 1LG using the light guide plates 1 of Examples 1-1 to 1-3, which have structures similar to that of Embodiment 1, a first sample 1A shown in FIG. 15 and a second sample 1B shown in FIG. 16 were examined for each of the light guide plates 1 of Examples 1-1 to 1-3. The first sample 1A sequentially included the second substrate 50, the photoalignment film 20, and the polymerized liquid crystal layer 30. The second sample 1B sequentially included the first substrate 10, the photoalignment film 20, the polymerized liquid crystal layer 30, the adhesive layer 40, and the second substrate 50, corresponding to the light guide plates 1 of Examples 1-1 to 1-3.

The adhesive layer 40 and the second substrate 50 in Example 1-1 each had a refractive index of 1.6. The adhesive layer 40 and the second substrate 50 in Example 1-2 each had a refractive index of 1.7. The adhesive layer 40 and the second substrate 50 in Example 1-3 each had a refractive index of 1.8. The first substrate 10 in each of Example 1-1 to Example 1-3 had a refractive index of 1.5.

### <Viewing Angle Evaluation for Green Display (Green Light)>

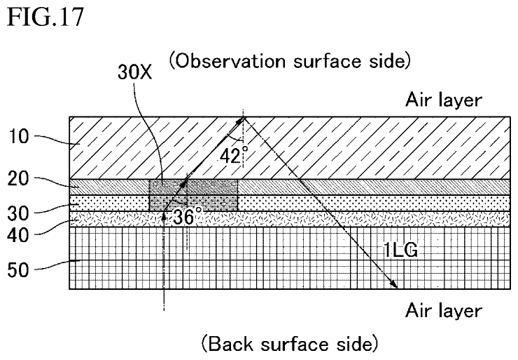

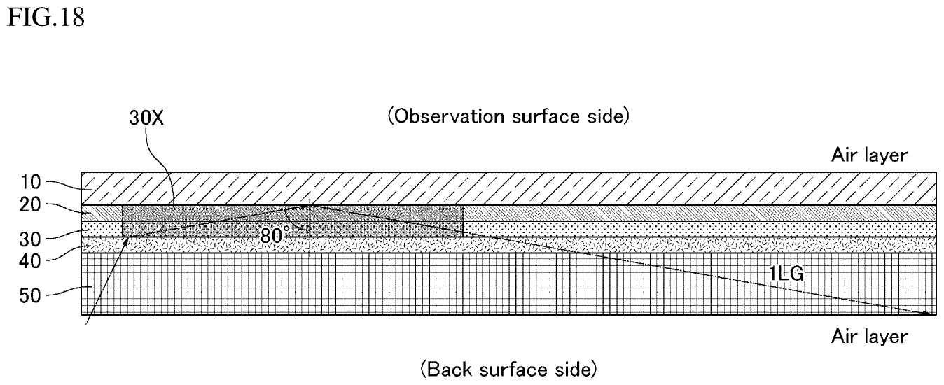

FIG. 17 is a schematic cross-sectional view illustrating the minimum viewing angle of the light guide plates of Examples 1-1 to 1-3. FIG. 18 is a schematic cross-sectional view illustrating the maximum viewing angle of the light guide plates of Examples 1-1 to 1-3. The method used to evaluate the viewing angle for green display in the first sample 1A was the same as that in Comparative Example 1. For the second sample 1B, the total internal reflection conditions of the first sample 1A still hold in accordance with Snell's law given by equation (8) below (FIG. 17 and FIG. 18).

nₒᵤₜ sin θₒᵤₜ=nᵢₙ sin θᵢₙ (Equation 8)

The critical angle of the light guide plate 1 of Example 1-2 in which the second substrate 50 had a refractive index of 1.7 (the critical angle for light incident from the second substrate 50 onto the air layer) was 36° (specifically, 36.032°) as derived from Snell's law given by equation (8). When light was incident from the second substrate 50 onto the first substrate 10 at 36°, the incidence angle of light from the first substrate 10 onto the air layer (critical angle for light incident from the first substrate 10 onto the air layer) was 42°, satisfying the total internal reflection conditions. Light incident from the second substrate 50 onto the first substrate 10 at the maximum angle satisfying the total internal reflection condition, 80°, was found to satisfy the inequality (9) below, indicating that the light remained guided within the second substrate 50 without entering the first substrate 10.

1.7 sin 80°>1×sin 90° (Inequality9)

Similar results were obtained using the light guide plate 1 of Example 1-1 in which the second substrate 50 had a refractive index of 1.6 and the light guide plate 1 of Example 1-3 in which the second substrate had a refractive index of 1.8, showing that the viewing angle of the first sample 1A and the viewing angle of the second sample 1B were the same. In other words, the viewing angle of the light guide plate 1 of Example 1-1 (the second sample 1B of Example 1-1) including the first substrate 10 having a refractive index of 1.5 and the second substrate 50 having a refractive index of 1.6 was found to be the same as the viewing angle of the first sample 1A of Example 1-1 including the second substrate 50 having a refractive index of 1.6. The viewing angle of the light guide plate 1 of Example 1-2 (the second sample 1B of Example 1-2) including the first substrate 10 having a refractive index of 1.5 and the second substrate 50 having a refractive index of 1.7 was found to be the same as the viewing angle of the first sample 1A of Example 1-2 including the second substrate 50 having a refractive index of 1.7. The viewing angle of the light guide plate 1 of Example 1-3 (the second sample 1B of Example 1-3) including the first substrate 10 having a refractive index of 1.5 and the second substrate 50 having a refractive index of 1.8 was found to be the same as the viewing angle of the first sample 1A of Example 1-3 including the second substrate 50 having a refractive index of 1.8. Therefore, the viewing angles of the first samples 1A of Example 1-1 to Example 1-3 were determined by simulation, and the determined viewing angles were taken as the viewing angles of the light guide plates 1 of Example 1-1 to Example 1-3, respectively. The simulation results of the viewing angles are shown in Table 4 below together with the results of Comparative Example 1.

TABLE 4

| | Comparative | | | |
|---|---|---|---|---|
| | Example 1 | Example 1-1 | Example 1-2 | Example 1-3 |
| Refractive | 1.5 | 1.6 | 1.7 | 1.8 |
| index of | | | | |
| second | | | | |
| substrate | | | | |
| Viewing | 28 | 33 | 39 | 45 |
| angle [°] | | | | |

The detailed results for Example 1-1 are shown in equation (10) and equation (11) below. Equation (10) shows the calculation results when the minimum angle for guiding light within the second substrate 50 was assumed to be 39°. Equation (11) shows the calculation results when the minimum angle for guiding light within the second substrate 50 was assumed to be 38.682°. The viewing angle obtained from equation (10) was 33.045°. The viewing angle obtained from equation (11) was 33.458°.

$$〈 Curvature 1.6 〉 Minimum angle = 39 ° \approx 38.682 \qquad ( Equation 10 )$$

$$\begin{matrix}sin ( θ ) = ( 1.6 \times sin 80 ° - 1.6 \times sin 39 ° ) / 2 & \approx & 0.284 \\ θ & \approx & 16.522 \\ Λ = 532 / ( 1.6 \times sin 39 ° + sin ( θ ) ) & \approx & 411.987 \\ = 532 / ( 1.6 \times sin 80 ° - sin ( θ ) ) & \approx & 411.987\end{matrix}$$

$$〈 Curvature 1.6 〉 Minimum angle = 39 ° \approx 38.682 \qquad ( Equation 11 )$$

$$\begin{matrix}sin ( θ ) = ( 1.6 \times sin 80 ° - 1.6 \times sin 39 ° ) / 2 & \approx & 0.288 \\ θ & \approx & 16.729 \\ Λ = 532 / ( 1.6 \times sin 39 ° + sin ( θ ) ) & \approx & 413.093 \\ = 532 / ( 1.6 \times sin 80 ° - sin ( θ ) ) & \approx & 413.093\end{matrix}$$

The detailed results for Example 1-2 are shown in equation (12) and equation (13) below. Equation (12) shows the calculation results obtained when the minimum angle for guiding light within the second substrate 50 was assumed to be 36°. Equation (13) shows the calculation results obtained when the minimum angle for guiding light within the second substrate 50 was assumed to be 36.032°. The viewing angle obtained from equation (12) was 39.446°. The viewing angle obtained from equation (13) was 39.399°.

$$〈 Curvature 1.7 〉 Minimum angle = 36 ° \approx 36.032 \qquad ( Equation 12 )$$

$$\begin{matrix}sin ( θ ) = ( 1.7 \times sin 80 ° - 1.7 \times sin 36 ° ) / 2 & \approx & 0.337 \\ θ & \approx & 19.723 \\ Λ = 532 / ( 1.7 \times sin 36 ° + sin ( θ ) ) & \approx & 397.994 \\ = 532 / ( 1.7 \times sin 80 ° - sin ( θ ) ) & \approx & 397.994\end{matrix}$$

$$〈 Curvature 1.7 〉 Minimum angle = 36 ° \approx 36.032 \qquad ( Equation 13 )$$

$$\begin{matrix}sin ( θ ) = ( 1.7 \times sin 80 ° - 1.7 \times sin 36 ° ) / 2 & \approx & 0.337 \\ θ & \approx & 19.699 \\ Λ = 532 / ( 1.7 \times sin 36 ° + sin ( θ ) ) & \approx & 397.88 \\ = 532 / ( 1.7 \times sin 80 ° - sin ( θ ) ) & \approx & 397.88\end{matrix}$$

The detailed results for Example 1-3 are shown in equation (14) and equation (15) below. Equation (14) shows the calculation results obtained when the minimum angle for guiding light within the second substrate 50 was assumed to be 34°. Equation (15) shows the calculation results obtained when the minimum angle for guiding light within the second substrate 50 was assumed to be 33.749°. The viewing angle obtained from equation (14) was 45.046°. The viewing angle obtained from equation (15) was 45.452°.

$$〈 Curvature 1.8 〉 Minimum angle = 34 ° \approx 33.749 \qquad ( Equation 14 )$$

$$\begin{matrix}sin ( θ ) = ( 1.8 \times sin 80 ° - 1.8 \times sin 34 ° ) / 2 & \approx & 0.383 \\ θ & \approx & 22.523 \\ Λ = 532 / ( 1.8 \times sin 34 ° + sin ( θ ) ) & \approx & 382.844 \\ = 532 / ( 1.8 \times sin 80 ° - sin ( θ ) ) & \approx & 382.844\end{matrix}$$

$$〈 Curvature 1.8 〉 Minimum angle = 34 ° \approx 33.749 \qquad ( Equation 15 )$$

$$\begin{matrix}sin ( θ ) = ( 1.8 \times sin 80 ° - 1.8 \times sin 34 ° ) / 2 & \approx & 0.386 \\ θ & \approx & 22.726 \\ Λ = 532 / ( 1.8 \times sin 34 ° + sin ( θ ) ) & \approx & 383.748 \\ = 532 / ( 1.8 \times sin 80 ° - sin ( θ ) ) & \approx & 383.748\end{matrix}$$

The results obtained from equation (10), equation (12), and equation (14) are shown in Table 5. The results obtained from equation (11), equation (13), and equation (15) are shown in Table 6.

TABLE 5

| | Example 1-1 | Example 1-2 | Example 1-3 |
|---|---|---|---|
| Refractive index of | 1.6 | 1.7 | 1.8 |
| second substrate | | | |
| Viewing angle [°] | 33.045 | 39.446 | 45.046 |

TABLE 6

| | Example 1-1 | Example 1-2 | Example 1-3 |
|---|---|---|---|
| Refractive index of | 1.6 | 1.7 | 1.8 |
| second substrate | | | |
| Viewing angle [°] | 33.458 | 39.399 | 45.452 |

Examples 1-1 to 1-3 and Comparative Example 1 demonstrated that increasing the refractive indices of the constituent components results in an increase in viewing angle. The viewing angle was found to increase also when a high-refractive-index substrate was attached to a low-refractive-index substrate. These results indicate that the preferred conditions are that the light guide plate 1 includes the second substrate 50, the adhesive layer 40, the polymerized liquid crystal layer 30, the photoalignment film 20, and the first substrate 10 in this order, that the second substrate 50 has a higher refractive index than the first substrate 10, and that the adhesive layer 40 has a higher refractive index than the first substrate 10.

### Examples 2-1 to 2-3

### <RGB Viewing Angle Evaluation>

In Examples 2-1 to 2-3, the RGB viewing angle was evaluated using the light guide plates 1 of Examples 1-1 to 1-3, respectively, as in Comparative Example 2. The results are shown in Table 7 below. The evaluation was performed using the first samples 1A of Example 1-1 to Example 1-3.

TABLE 7

| | | Wavelength | | |
|---|---|---|---|---|
| | | 450 nm | 532 nm | 620 nm |
| Example 2-1 | Minimum viewing | −5 | −17 | −30 |
| Refractive index | angle [°] | | | |
| of second | Maximum viewing | 29 | 17 | 4 |
| substrate: 1.6 | angle [°] | | | |
| Example 2-2 | Minimum viewing | −8 | −20 | −34 |
| Refractive index | angle [°] | | | |
| of second | Maximum viewing | 33 | 20 | 7 |
| substrate: 1.7 | angle [°] | | | |
| Example 2-3 | Minimum viewing | −10 | −23 | −38 |
| Refractive index | angle [°] | | | |
| of second | Maximum viewing | 37 | 23 | 9 |
| substrate: 1.8 | angle [°] | | | |

The detailed results for Example 2-1 are shown in equation (16) and equation (17) below. Equation (16) shows the calculation results obtained when the minimum angle for guiding light within the second substrate 50 was assumed to be 39°. Equation (17) shows the calculation results obtained when the minimum angle for guiding light within the second substrate 50 was assumed to be 38.682°.

$$〈 Curvature 1.6 〉 Minimum angle = 39 ° \qquad ( Equation 16 )$$

$$\begin{matrix}Blue light : sin ( - θ ) = 1.6 \times sin 39 ° - \frac{450}{Λ} & \approx & - 0.085 \\ Blue light : - θ & \approx & - 4.896 \\ Blue light : sin ( + θ ) = 1.6 \times sin 80 ° - \frac{450}{Λ} & \approx & 0.483 \\ Blue light : + θ & \approx & 28.909 \\ Red light : sin ( - θ ) = 1.6 \times sin 39 ° - \frac{620}{Λ} & \approx & - 0.498 \\ Red light : - θ & \approx & - 29.867 \\ Red light : sin ( + θ ) = 1.6 \times sin 80 ° - \frac{620}{Λ} & \approx & 0.071 \\ Red light : + θ & \approx & 4.059\end{matrix}$$

$$〈 Curvature 1.6 〉 Minimum angle = 39 ° \qquad ( Equation 17 )$$

$$\begin{matrix}Blue light : sin ( - θ ) = 1.6 \times sin 39 ° - \frac{450}{Λ} & \approx & - 0.089 \\ Blue light : - θ & \approx & - 5.126 \\ Blue light : sin ( + θ ) = 1.6 \times sin 80 ° - \frac{450}{Λ} & \approx & 0.486 \\ Blue light : + θ & \approx & 29.101 \\ Red light : sin ( - θ ) = 1.6 \times sin 39 ° - \frac{620}{Λ} & \approx & - 0.501 \\ Red light : - θ & \approx & - 30.058 \\ Red light : sin ( + θ ) = 1.6 \times sin 80 ° - \frac{620}{Λ} & \approx & 0.075 \\ Red light : + θ & \approx & 4.291\end{matrix}$$

The detailed results for Example 2-2 are shown in equation (18) and equation (19) below. Equation (18) shows the calculation results obtained when the minimum angle for guiding light within the second substrate 50 was assumed to be 36°. Equation (19) shows the calculation results obtained when the minimum angle for guiding light within the second substrate 50 was assumed to be 36.032°.

$$〈 Curvature 1.7 〉 Minimum angle = 36 ° \qquad ( Equation 18 )$$

$$\begin{matrix}Blue light : sin ( - θ ) = 1.7 \times sin 36 ° - \frac{450}{Λ} & \approx & - 0.131 \\ Blue light : - θ & \approx & - 7.553 \\ Blue light : sin ( + θ ) = 1.7 \times sin 80 ° - \frac{450}{Λ} & \approx & 0.544 \\ Blue light : + θ & \approx & 32.922 \\ Red light : sin ( - θ ) = 1.7 \times sin 36 ° - \frac{620}{Λ} & \approx & - 0.559 \\ Red light : - θ & \approx & - 33.958 \\ Red light : sin ( + θ ) = 1.7 \times sin 80 ° - \frac{620}{Λ} & \approx & 0.116 \\ Red light : + θ & \approx & 6.682\end{matrix}$$

$$〈 Curvature 1.7 〉 Minimum angle = 36 ° \qquad ( Equation 19 )$$

$$\begin{matrix}Blue light : sin ( - θ ) = 1.7 \times sin 36 ° - \frac{450}{Λ} & \approx & - 0.131 \\ Blue light : - θ & \approx & - 7.527 \\ Blue light : sin ( + θ ) = 1.7 \times sin 80 ° - \frac{450}{Λ} & \approx & 0.543 \\ Blue light : + θ & \approx & 32.9 \\ Red light : sin ( - θ ) = 1.7 \times sin 36 ° - \frac{620}{Λ} & \approx & - 0.558 \\ Red light : - θ & \approx & - 33.935 \\ Red light : sin ( + θ ) = 1.7 \times sin 80 ° - \frac{620}{Λ} & \approx & 0.116 \\ Red light : + θ & \approx & 6.656\end{matrix}$$

The detailed results for Example 2-3 are shown in equation (20) and equation (21) below. Equation (20) shows the calculation results obtained when the minimum angle for guiding light within the second substrate 50 was assumed to be 34°. Equation (21) shows the calculation results obtained when the minimum angle for guiding light within the second substrate 50 was assumed to be 33.749°.

$$〈 Curvature 1.8 〉 Minimum angle = 34 ° \qquad ( Equation 20 )$$

$$\begin{matrix}Blue light : sin ( - θ ) = 1.8 \times sin 34 ° - \frac{450}{Λ} & \approx & - 0.169 \\ Blue light : - θ & \approx & - 9.722 \\ Blue light : sin ( + θ ) = 1.8 \times sin 80 ° - \frac{450}{Λ} & \approx & 0.597 \\ Blue light : + θ & \approx & 36.672 \\ Red light : sin ( - θ ) = 1.8 \times sin 34 ° - \frac{620}{Λ} & \approx & - 0.613 \\ Red light : - θ & \approx & - 37.8 \\ Red light : sin ( + θ ) = 1.8 \times sin 80 ° - \frac{620}{Λ} & \approx & 0.153 \\ Red light : + θ & \approx & 8.812\end{matrix}$$

$$〈 Curvature 1.8 〉 Minimum angle = 34 ° \qquad ( Equation 21 )$$

$$\begin{matrix}Blue light : sin ( - θ ) = 1.8 \times sin 34 ° - \frac{450}{Λ} & \approx & - 0.173 \\ Blue light : - θ & \approx & - 9.942 \\ Blue light : sin ( + θ ) = 1.8 \times sin 80 ° - \frac{450}{Λ} & \approx & 0.6 \\ Blue light : + θ & \approx & 36.871 \\ Red light : sin ( - θ ) = 1.8 \times sin 34 ° - \frac{620}{Λ} & \approx & - 0.616 \\ Red light : - θ & \approx & - 37.999 \\ Red light : sin ( + θ ) = 1.8 \times sin 80 ° - \frac{620}{Λ} & \approx & 0.157 \\ Red light : + θ & \approx & 9.033\end{matrix}$$

The results obtained from equation (16), equation (18), and equation (20) are shown in Table 8. The results obtained from equation (17), equation (19), and equation (21) are shown in Table 9.

TABLE 8

| | | Wavelength | | |
|---|---|---|---|---|
| | | 450 nm | 532 nm | 620 nm |
| Example 2-1 | Minimum viewing | −4.896 | −16.522 | −29.867 |
| Refractive index | angle [°] | | | |
| of second | Maximum viewing | 28.909 | 16.522 | 4.059 |
| substrate: 1.6 | angle [°] | | | |
| Example 2-2 | Minimum viewing | −7.553 | −19.723 | −33.958 |
| Refractive index | angle [°] | | | |
| of second | Maximum viewing | 32.922 | 19.723 | 6.682 |
| substrate: 1.7 | angle [°] | | | |
| Example 2-3 | Minimum viewing | −9.722 | −22.523 | −37.800 |
| Refractive index | angle [°] | | | |
| of second | Maximum viewing | 36.672 | 22.523 | 8.812 |
| substrate: 1.8 | angle [°] | | | |

TABLE 9

| | | Wavelength | | |
|---|---|---|---|---|
| | | 450 nm | 532 nm | 620 nm |
| Example 2-1 | Minimum viewing | −5.126 | −16.729 | −30.058 |
| Refractive index | angle [°] | | | |
| of second | Maximum viewing | 29.101 | 16.729 | 4.291 |
| substrate: 1.6 | angle [°] | | | |
| Example 2-2 | Minimum viewing | −7.527 | −19.699 | −33.935 |
| Refractive index | angle [°] | | | |
| of second | Maximum viewing | 32.900 | 19.699 | 6.656 |
| substrate: 1.7 | angle [°] | | | |
| Example 2-3 | Minimum viewing | −9.942 | −22.726 | −37.999 |
| Refractive index | angle [°] | | | |
| of second | Maximum viewing | 36.871 | 22.726 | 9.033 |
| substrate: 1.8 | angle [°] | | | |

Table 10 below shows the overlapping range of all the colors as determined from the results in Table 7 above.

TABLE 10

| | Comparative | | | |
|---|---|---|---|---|
| | Example 2 | Example 2-1 | Example 2-2 | Example 2-3 |
| Refractive | 1.5 | 1.6 | 1.7 | 1.8 |
| index of | | | | |
| second | | | | |
| substrate | | | | |
| Viewing | 5 | 9 | 14 | 19 |
| angle [°] | | | | |

Table 11 below shows the overlapping range of all the colors as determined from the results in Table 8 above.

TABLE 11

| | Comparative | | | |
|---|---|---|---|---|
| | Example 2 | Example 2-1 | Example 2-2 | Example 2-3 |
| Refractive | 1.5 | 1.6 | 1.7 | 1.8 |
| index of | | | | |
| second | | | | |
| substrate | | | | |
| Viewing | 4.420 | 8.956 | 14.235 | 18.534 |
| angle [°] | | | | |

Table 12 below shows the overlapping range of all the colors as determined from the results in Table 9 above.

TABLE 12

| | Comparative | | | |
|---|---|---|---|---|
| | Example 2 | Example 2-1 | Example 2-2 | Example 2-3 |
| Refractive | 1.5 | 1.6 | 1.7 | 1.8 |
| index of | | | | |
| second | | | | |
| substrate | | | | |
| Viewing | 4.666 | 9.417 | 14.183 | 18.975 |
| angle [°] | | | | |

Tables 10 to 12 show that, as in Examples 1-1 to 1-3, increasing the refractive index of the second substrate 50 results in an increase in the RGB viewing angle. The viewing angle was found to increase also when a high-refractive-index substrate was attached to a low-refractive-index substrate. The refractive index of the second substrate 50 was found to be particularly preferably 1.7 or higher, as such a value resulted in an RGB viewing angle of 14° or greater.

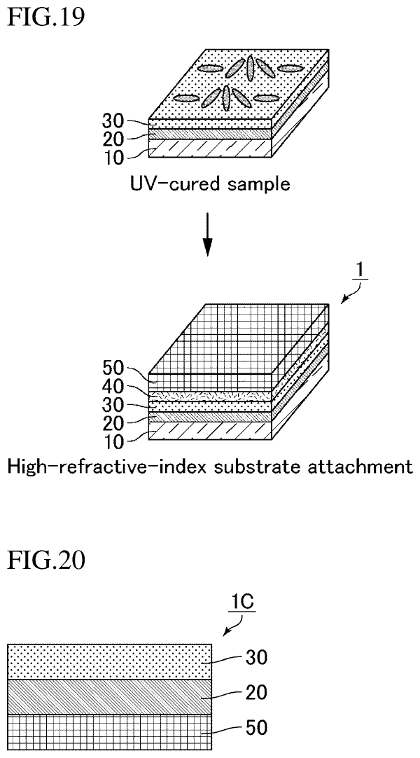

FIG. 19 is a schematic view illustrating a method of producing a light guide plate of Example 3. FIG. 20 is a schematic cross-sectional view of a light guide plate of a reference example. In Example 3, an actually produced light guide plate 1 of Example 1-3 was used to examine display images. The light guide plate 1 of Example 3 was produced by performing the process up to the UV-curing step in the same manner as in Comparative Example 3. Then, as shown in FIG. 19, the second substrate 50 having a refractive index of 1.8 was attached to the UV-cured sample using the adhesive layer 40, so that the light guide plate 1 of Example 3 was produced. Additionally, as shown in FIG. 20, a light guide plate 1C of a reference example was prepared which included the second substrate 50 having a refractive index of 1.8, the photoalignment film 20, and the polymerized liquid crystal layer 30.

### <Method of Evaluating Display Image>

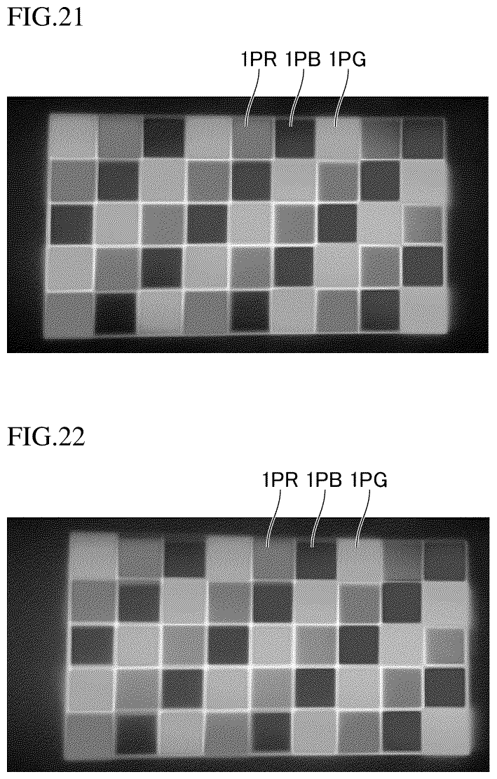

FIG. 21 is an image emitted from the light guide plate of Example 3. FIG. 22 is an image emitted from the light guide plate of the reference example. The display image was evaluated in the same manner as in Comparative Example 3 for the light guide plate 1 of Example 3 and the light guide plate 1C of the reference example. The results are shown in FIG. 21 and FIG. 22.

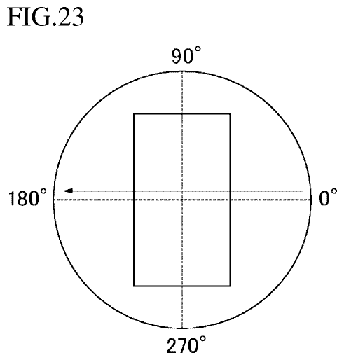

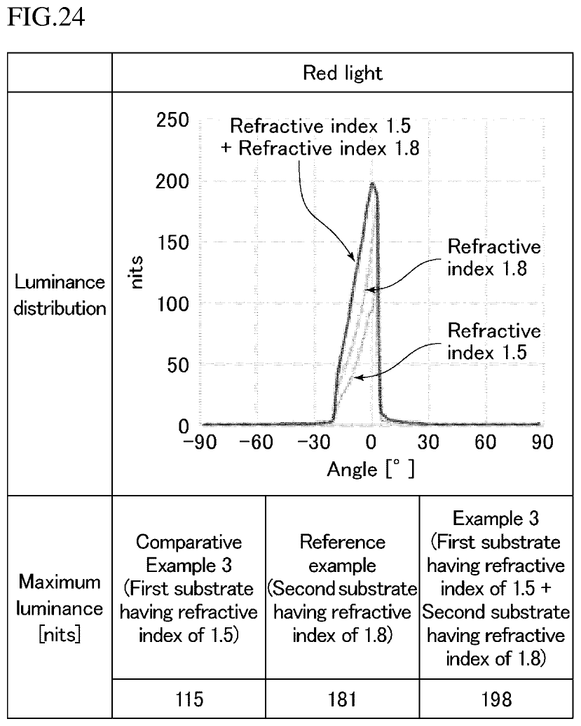

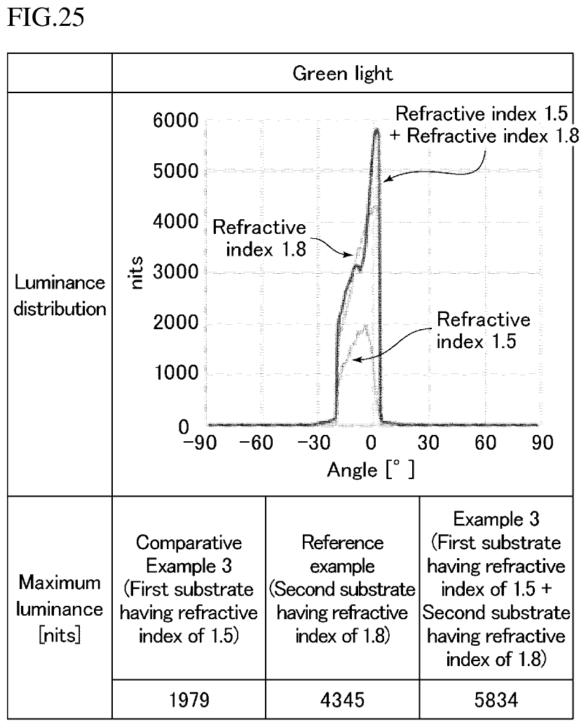

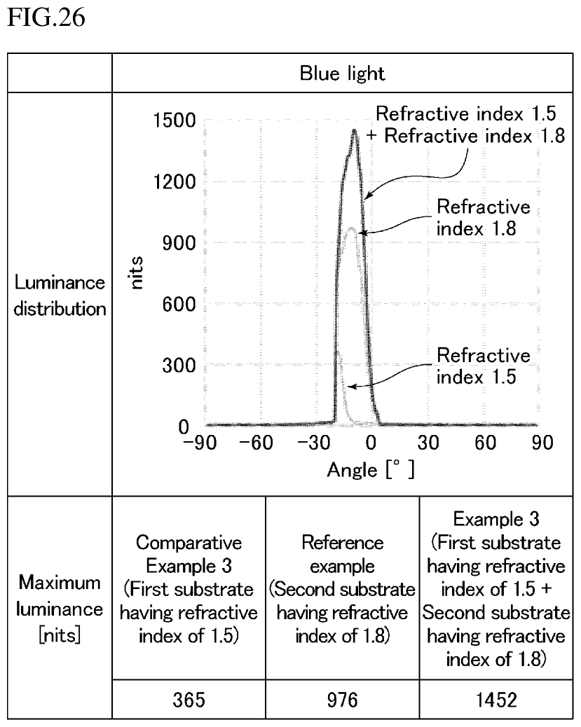

FIG. 23 schematically shows an image for measuring luminance distribution. FIG. 24 shows the results of luminance distribution measurement when red light is displayed. FIG. 25 shows the results of luminance distribution measurement when green light is displayed. FIG. 26 shows the results of luminance distribution measurement when blue light is displayed.

Furthermore, for Example 3, the reference example, and Comparative Example 3, the luminance distribution at the 0°-180° azimuth while measurement images of red light ILR, green light 1LG, and blue light ILB were displayed was measured using a viewing-angle measurement/evaluation device according to the measurement method shown in FIG. 12. During measurement for Example 3, the light guide plate was positioned such that light from the projector 2 was incident from the second substrate 50 side, and the image emitted from the first substrate 10 side was captured by the camera 3. For the reference example, the light guide plate was positioned such that light from the projector 2 was incident from the second substrate 50 side, and the image emitted from the polymerized liquid crystal layer 30 side was captured by the camera 3. For Comparative Example 3, the light guide plate was positioned such that light from the projector 2 was incident from the first substrate 10R side, and the image emitted from the polymerized liquid crystal layer 30R side was captured by the camera 3. The measurement image is shown in FIG. 23. The measured results are shown in FIG. 24 to FIG. 26.

FIG. 21 and FIG. 22 show that when the refractive indices of the constituent components are increased, the region where the RGB elements are displayed is in fact widened. FIG. 24 to FIG. 26 show that in a comparison between a light guide plate including a high-refractive-index substrate (the light guide plate of the reference example) and a light guide plate including a high-refractive-index substrate attached to a low-refractive-index substrate (the light guide plate of Example 3), equivalent viewing angles were obtained. Additionally, the light guide plate of Example 3 exhibited an improved luminance as compared to the light guide plate of the reference example. Since the light guide plate of Example 3 was thicker than the light guide plate of the reference example, the number of total internal reflections decreased (the light loss was reduced) in the light guide plate of Example 3 compared to the light guide plate of the reference example, which presumably improved the luminance. Here, a diffractive element may be disposed on the high-refractive-index substrate (second substrate 50) in the light guide plate of Example 3, and then the substrate may be attached to the low-refractive-index substrate (first substrate 10).

Although embodiments of the present disclosure and modifications thereof have been described, the scope of the present disclosure is not limited to such embodiments and modifications. Various forms and modifications thereof can be made without departing from the gist of the present disclosure. In addition, the plurality of elements disclosed in the embodiments and modifications thereof described above may be altered as appropriate. For example, a certain element among all the elements shown in one embodiment or modification thereof may be added to the elements of another embodiment or modification thereof, or some elements among all the elements shown in one embodiment or modification thereof may be removed from the embodiment or modification thereof.

The drawings are schematic illustrations in which the elements are mainly shown for ease of understanding of the disclosure. Therefore, the thickness, length, number, spacing, and the like of the respective elements illustrated in the drawings may differ from actual values for convenience of illustration. Moreover, the configurations of the respective elements described in the above embodiments are merely examples and are not intended to be limiting, and various modifications may be made without substantially departing from the effects of the present disclosure.

What is claimed is:

1: A light guide plate sequentially comprising:
a first substrate;
a photoalignment film;
a polymerized liquid crystal layer containing a cured product of a polymerizable liquid crystal;
an adhesive layer; and
a second substrate having a different refractive index from the first substrate,
the light guide plate further comprising
a diffractive element.

2: The light guide plate according to claim 1,
wherein the second substrate and the adhesive layer each have a higher refractive index than the first substrate.

3: The light guide plate according to claim 1,
wherein the second substrate and the adhesive layer each have a refractive index that is higher than the refractive index of the first substrate by 0.1 or more.

4: The light guide plate according to claim 1,
wherein the second substrate and the adhesive layer each have a refractive index of 1.7 or higher.

5: The light guide plate according to claim 1,
wherein a difference between the refractive index of the second substrate and a refractive index of the adhesive layer is 0.2 or less.

6: The light guide plate according to claim 1,
wherein the polymerized liquid crystal layer includes a portion constituting the diffractive element and a portion not constituting the diffractive element.

7: The light guide plate according to claim 1, which comprises the diffractive element including at least a portion of the polymerized liquid crystal layer, and another diffractive element disposed between the adhesive layer and the second substrate.

8: The light guide plate according to claim 1,
wherein in a plan view, the second substrate is smaller than the first substrate.

9: The light guide plate according to claim 8,
wherein in a plan view, an outer edge of the second substrate is positioned inward relative to an outer edge of the first substrate.

10: An AR display device comprising:
the light guide plate according to claim 1; and
a display module facing the light guide plate.

11: The AR display device according to claim 10,
wherein the polymerized liquid crystal layer includes a portion constituting an input diffractive element in the diffractive element, a portion constituting an output diffractive element in the diffractive element, and a portion not constituting the diffractive element, and
the display module faces the portion constituting the input diffractive element.
